(19) United States
(12) Patent Application Publication
(10) Pub. No.: US 2012/0056571 A1
(43) Pub. Date: Mar. 8, 2012

(54) ELECTRIC DRIVE SYSTEM

(75) Inventors: Marcel Buse, Enschede (NL); Söhnke Früchtenicht, Luneburg (DE); Gaston Mathijssen, Borne (NL); Etienne Meier, Hengelo (NL); Axel Möhle, Berlin (DE)

(73) Assignee: SIEMENS AKTIENGESSELLSCHAFT, MUNCHEN (DE)

(21) Appl. No.: 13/319,837

(22) PCT Filed: Apr. 15, 2010
(86) PCT No.: PCT/EP10/54975

§ 371 Date: Nov. 10, 2011

(30) Foreign Application Priority Data
May 13, 2009 (DE) 10 2009 021 098.9

(51) Int. Cl. H02P 31/00

(52) U.S. Cl. 318/558

(57) ABSTRACT

The invention relates to a drive system comprising a liquid-cooling electric machine (1), and to a method for liquid-cooling the stator winding of said type of machine (1). In order to use said system at very low temperatures and in the most simple way possible, said drive system also comprises a cooling circuit (2) for cooling the liquid of a stator winding of the electric machine (1), a pump (3) for pumping a liquid through the coolant circuit (2), a converter (4) for feeding the stator winding and a control device (5) for controlling the converter in such a manner that said converter, prior to activating the pump (3), feeds a heating flow to the stator winding for heating the cool liquid.

The invention relates to a drive system with a liquid-cooled electrical machine and a method for liquid cooling the stator winding of such a machine.

In electrical machines, the winding of the stator needs to be cooled by a medium in order to avoid impermissibly high operating temperatures. In the simplest case, air is used as cooling medium. Relatively high powers with at the same time a relatively compact design can be achieved by liquid cooling however. Therefore, the stator winding of an electrical machine, in particular in the case of medium and relatively high powers, is often cooled by a cooling liquid which is pumped through a cooling circuit with the aid of a pump. In this case, the cooling liquid used is often oil, in particular an insulating oil. The pump circulates the cooling liquid in the closed cooling circuit surrounding the motor and a heat exchanger.

Depending on the field of use, an electrical machine and therefore also the insulating oil used for cooling said electrical machine can be subjected to very low ambient temperatures. For example, electrical machines are used for driving compressors which are used for conveying, transporting and processing natural gas. Compressors for the oil and gas market are often used in extreme locations such as the Arctic or on the sea bed (subsea). It is obvious that the electrical machines which are used for driving the compressor used can also be subjected to extremely low temperatures in the process.

Low ambient temperatures result in a very high viscosity of the insulating oil, with the result that said insulating oil can sometimes not be pumped through the cooling circuit by the pump. In such cases, the oil needs to be preheated in advance with the aid of an additional heater before the pump is switched on, said heater being provided separately from the motor and the cooling apparatus as an additional assembly in the cooling circuit.

The invention is based on the object of enabling the use of liquid-cooled dynamoelectric machines at very low ambient temperatures with as little complexity as possible.

This object is achieved by an electric drive system having
an electrical machine,
a cooling circuit for the liquid cooling of a stator winding of the electrical machine,
a pump for pumping a cooling liquid through the cooling circuit,
a converter for feeding the stator winding, and
a control device for driving the converter such that said converter feeds a heating current into the stator winding for heating the cooling liquid prior to the pump being switched on.

In addition, the object is achieved by a method for liquid cooling a stator winding of an electrical machine of an electric drive system via a cooling circuit, wherein cooling liquid is pumped through the cooling circuit by a pump, and a heating current for heating the cooling liquid is fed to the stator winding by a converter prior to the pump being switched on.

Advantageous embodiments of the invention are given in the dependent claims.

Conventional variable-speed drives are generally fed by a converter. This converter usually comprises an input rectifier which converts a line-side AC voltage into an intermediate-circuit DC voltage or a line-side alternating current into an intermediate-circuit direct current, and an inverter which applies or impresses the intermediate-circuit DC voltage or the intermediate-circuit direct current to or on the electrical machine. In this case, the inverter is driven by a control device such that the electrical variable generated thereby produces a predetermined motor speed or a predetermined motor torque. For this purpose, for example, the control device comprises a controller which calculates a setpoint current to be impressed on the stator winding from a discrepancy between a setpoint rotation speed value and an actual rotation speed value and from this selects corresponding switching signals for the power semiconductors of the inverter.

The above-described operating mode corresponds to the generally known intended operation of a variable-speed electric drive.

The invention is now based on the knowledge that the described components, namely the control unit, the converter and the stator winding, can also be used for heating the cooling liquid, in addition to their function of producing a rotating field. In this way, it is possible to make savings with respect to external heating for the purpose of heating the cooling liquid. As a result, the costs for the electric drive unit can be reduced and its physical volume can be minimized. In order to provide the cooling liquid with a sufficiently low viscosity, a corresponding heating current is merely fed by the converter into the stator winding, with this heating current bringing the cooling liquid which is provided for cooling the stator winding per se to a required temperature. Only when this threshold temperature has been exceeded does the cooling liquid have a sufficiently low viscosity to be circulated in the cooling circuit by the pump.

The invention is particularly advantageous in an embodiment in which the cooling liquid is oil. Since oil becomes extremely viscous at very low temperatures, in this case heating the oil by means of the stator winding enables circulation of this coolant in a very simple manner.

In order to avoid the generation of an as yet undesired torque for the electrical machine during the heating phase, the heating current is a direct current in an advantageous configuration of the invention. A steady-state magnetic field in the air gap of the electrical machine is induced by a direct current impressed on the stator winding, and the rotor of the machine is then not driven by this field. The use of a direct current furthermore has the advantage that no eddy current losses and hysteresis losses can be produced in the rotor of the machine.

However, in an alternative configuration of the invention, the development of a torque can also be prevented by the heating current being an alternating current used to induce an alternating field in an air gap of the electrical machine. In order to prevent the generation of a torque, it is merely critical to avoid an alternating magnetic field in the air gap. Although it is not possible when using an alternating current for the heating current to completely avoid rotor losses in the form of eddy currents and hysteresis, it is possible for an alternating current which does not have a rotating field to be produced with minimal complexity in terms of construction by means of the above-described converter, since said converter is already designed for feeding an alternating electrical variable into the stator winding for its intended use.

Bringing the electric drive system into operation at low ambient temperatures can be largely automated in an advantageous configuration of the invention by virtue of the fact that the electrical operating system has measuring instruments for detecting a measured variable characterizing the viscosity of the cooling liquid, wherein the control device is designed to produce a switch-on command for the pump in the event of a viscosity threshold value being undershot. In this case, when the electric drive system is switched on, the viscosity of the cooling liquid is monitored continuously. This can be performed, for example, by a temperature measurement of the cooling liquid as well, since the temperature of the cooling liquid gives an indication of the viscosity thereof. As soon as the control device has established that the viscosity is sufficiently low for enabling circulation of the cooling liquid by the pump, a corresponding switch-on signal is sent by the control device to the pump.

Advantageously, in such an embodiment, wherein the control device is designed such that it automatically drives the converter to feed an alternating current driving the electrical machine once the viscosity threshold value has been undershot. In this case, the entire switch-on operation of the electric drive system is automated from the time of heating of the cooling liquid up to the time at which the electric motor is ramped up.

An embodiment of the electric drive system described above can be combined very well with a compressor for compressing natural gas to form a motor/compressor unit, which is suitable in particular for use at extremely low external temperatures. An advantageous use sector for such a motor/compressor unit is provided in one embodiment, for example, in which said unit is designed for subsea use. In this case, a particular potential use would be for conveying and processing natural gas in Arctic climes.

The invention will be described in more detail and explained below with reference to the exemplary embodiments illustrated in the figures, in which:

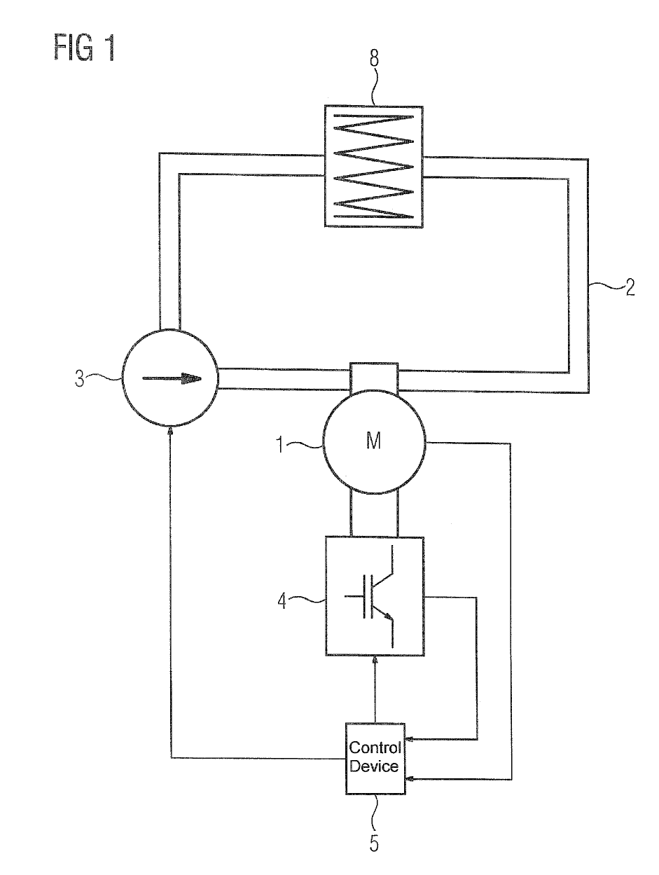

FIG. 1 shows a schematic illustration of an embodiment of the electric drive system according to the invention, and

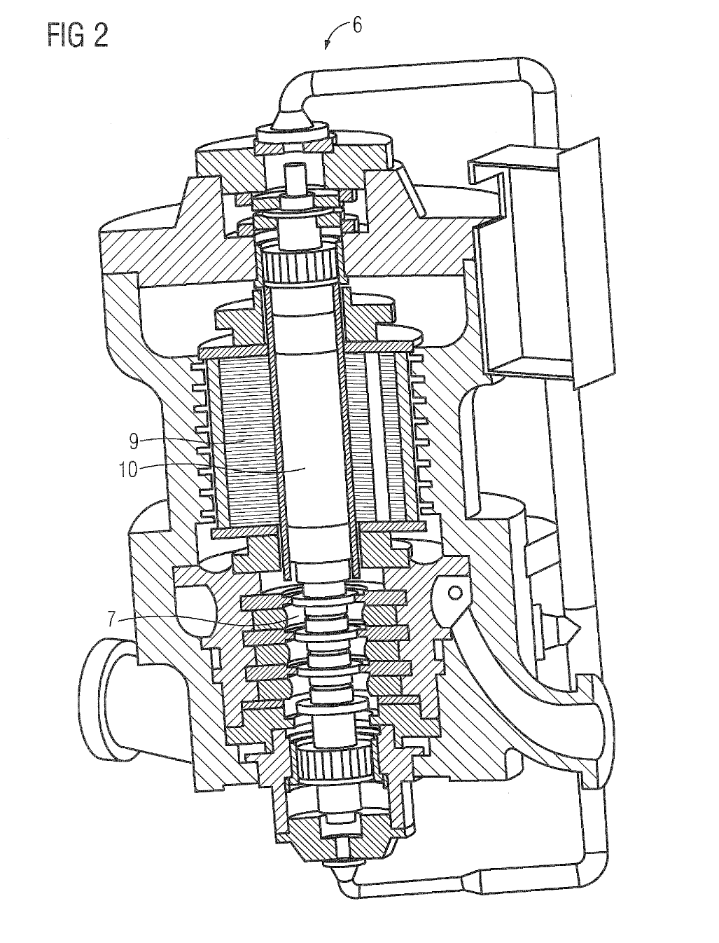

FIG. 2 shows a motor/compressor unit in accordance with one configuration of the invention.

FIG. 1 shows a schematic illustration of an embodiment of the electric drive system according to the invention. A central component of this electric drive system is an electrical machine 1, which has a liquid-cooled stator winding. An alternating current which is generated by the rotating field required for driving the rotor of the electrical machine 1 is fed to this stator winding by a converter 4. A control device 5 produces control commands for the power semiconductors of the converter 4. These control commands are produced by means of a suitable control algorithm depending on a discrepancy between an actual torque of the motor and a setpoint torque value input to the electrical machine 1. The torque of the electrical machine 1 can be measured for this purpose or can be determined by computation from a measurement of the stator currents of the electrical machine 1 and then supplied to the control device 5 as the actual value. An arrow pointing from the converter 4 to the control device 5 indicates the feedback of the actual stator currents used by the control device 5 as the basis for determining the torque of the electrical machine 1.

Furthermore, the temperature of the cooling liquid of the electrical machine 1 is detected and is likewise coupled onto the control device 5. This is also indicated by an arrow, which points from the electrical machine 1 to the control device 5.

The cooling liquid provided for cooling the stator winding, which in this example is an insulating oil, is pumped by a pump 3 through a cooling circuit 2, which comprises a heat exchanger 8, via which the insulting oil can emit its heat. If the drive system illustrated is used at very low ambient temperatures, it may arrive, however, that the insulating oil is too viscous to be circulated through the cooling circuit 2 by the pump 3. In such an operation case, the pump 3 is initially switched off. The electrical machine 1 is likewise still at a standstill and no torque is yet generated by the electrical machine 1 either. Instead, control commands for the power semiconductors of the converter 4 are generated initially by the control unit 5, and this results in direct currents being fed into the windings of the electrical machine 1. It is possible in this case for a direct current to be applied to each phase of the electrical machine 1. However, it is also possible for only one phase or two phases to be used for this purpose. The stator winding is heated with the aid of this direct current with the result that it can emit its heat to the cooling liquid. In this case, the direct current should of course only be selected to have such a high value as to prevent overheating of the stator winding. During this heating operation, the temperature of the cooling liquid is monitored, and the temperature of the cooling liquid gives an indication of the viscosity thereof. Above a certain threshold value for the viscosity and an associated threshold value for the temperature of the cooling liquid, a switch-on command is sent by the control device 5 to the pump 3. In response to this switch-on command, the pump 3 begins to circulate the cooling liquid in the cooling circuit 2. Furthermore, the converter 4 is switched over from the DC operating mode to the AC operating mode, with the result that an alternating current is supplied to the stator windings of the electrical machine 1, said alternating current having been produced by the rotating field required for driving the electrical machine 1.

The electric drive system described here makes it possible to use a liquid-cooled electric motor under extreme use conditions, in which an additional heating apparatus would be required in the prior art for heating the cooling liquid. The described system manages virtually without any additional hardware components and can therefore be realized particularly inexpensively and with a compact design.

FIG. 2 shows a motor/compressor unit in accordance with one configuration of the invention. The motor/compressor unit 6 illustrated here is intended for compressing natural gas and is suitable for use on the seabed (subsea). A multi-stage compressor 7 and an electrical machine suitable for driving said compressor and comprising a stator 9 and a rotor 10 are arranged within a gas-tight housing. The stator 9 is liquid-cooled. The cooling liquid used is an insulating oil which tends towards very high viscosities at the low ambient temperatures prevailing in the case of subsea use. In order that the insulating oil can be pumped through the cooling system by a circulating pump (not illustrated in any more detail), said insulating oil is first heated to a temperature at which it has a sufficiently low viscosity with the aid of a direct current or alternating current impressed on the stator windings, as described with respect to FIG. 1 above. An additional heating system is not required for this purpose.

What is claimed is:

1.-14. (canceled)

15. An electric drive system, comprising:
an electrical machine having a stator winding;
a cooling circuit for liquid cooling of the stator winding of the electrical machine;
a pump for pumping a cooling liquid through the cooling circuit;
a converter for feeding the stator winding; and
a control device for operating the converter such that the converter feeds a heating current into the stator winding for heating the cooling liquid prior to the pump being switched on.

16. The electric drive system of claim 15, wherein the cooling liquid is oil.

17. The electric drive system of claim 15, wherein the heating current is a direct current.

18. The electric drive system of claim 15, wherein the heating current is an alternating current used to induce an alternating field in an air gap of the electrical machine.

19. The electric drive system of claim 15, further comprising a measuring instrument for detecting a measured variable characterizing a viscosity of the cooling liquid, said control device being designed to produce a switch-on command for the pump when a viscosity threshold value is undershot.

20. The electric drive system of claim 19, wherein the control device is designed to automatically operate the converter to feed an alternating current driving the electrical machine when the viscosity threshold value is undershot.

21. A motor/compressor unit, comprising:
a compressor for compressing natural gas; and
an electric drive system operating the compressor and including an electrical machine having a stator winding, a cooling circuit for liquid cooling of the stator winding of the electrical machine, a pump for pumping a cooling liquid through the cooling circuit, a converter for feeding the stator winding, and a control device for operating the converter such that the converter feeds a heating current into the stator winding for heating the cooling liquid prior to the pump being switched on.

22. The motor/compressor unit of claim 21, wherein the cooling liquid is oil.

23. The motor/compressor unit of claim 21, wherein the heating current is a direct current.

24. The motor/compressor unit of claim 21, wherein the heating current is an alternating current used to induce an alternating field in an air gap of the electrical machine.

25. The motor/compressor unit of claim 21, further comprising a measuring instrument for detecting a measured variable characterizing a viscosity of the cooling liquid, said control device being designed to produce a switch-on command for the pump when a viscosity threshold value is undershot.

26. The motor/compressor unit of claim 25, wherein the control device is designed to automatically operate the converter to feed an alternating current driving the electrical machine when the viscosity threshold value is undershot.

27. The motor/compressor unit of claim 21, wherein the motor/compressor unit is designed for subsea use.

28. A method for liquid cooling a stator winding of an electrical machine of an electric drive system, comprising:
pumping cooling liquid through a cooling circuit of the electric drive system by a pump; and
feeding a heating current for heating the cooling liquid to the stator winding by a converter prior to the pump being switched on.

29. The method of claim 28, wherein the cooling liquid is oil.

30. The method of claim 28, wherein the feeding step includes feeding a direct current as heating current.

31. The method of claim 28, wherein the feeding step includes feeding an alternating current as heating current, with the alternating current being used to induce an alternating field in an air gap of the electrical machine.

32. The method of claim 28, further comprising detecting a measured variable characterizing a viscosity of the cooling liquid, and producing automatically a switch-on command for the pump when a viscosity threshold value is undershot.

33. The method of claim 32, wherein the feeding step includes feeding an alternating current driving the electrical machine into the stator winding automatically by the converter when the viscosity threshold value is undershot.
